(19) United States
(12) Patent Application Publication
(10) Pub. No.: US 2004/0139920 A1
(43) Pub. Date: Jul. 22, 2004

(54) Cultured pearl nuclei and method of fabricating same from calcium carbonate precursor powders

(76) Inventors: William M. Carty, Alfred Station, NY (US); Hyo Jin Lee, Almond, NY (US)

Correspondence Address: C. John Brannon, 2700 Market Tower, 10 West Market Street, Indianapolis, IN, 46204-4900, US

(21) Appl. No.: 10/346,839

(22) Filed: Jan. 17, 2003

(51) Int. Cl. A01K 61/00

(52) U.S. Cl. 119/244

(57) ABSTRACT

A method for producing a cultured pearl, including the forming a green body from a calcium carbonate precursor powder, equilibrating the moisture content of the green body to a level of between about 5 weight percent and about 8 weight percent, partially densifying the green body and spheroidizing the green body to a produce calcium carbonate sphere, sintering the calcium carbonate sphere to produce a densified seed, tumbling the densified seed in fluidized calcite, placing the densified seed between the mantle lobe and the shell of a bivalve, growing a pearl around the seed, and harvesting the pearl from the bivalve. Preferably, the pearl is grown over a duration of between about 6 months about 36 months.

### BACKGROUND OF THE INVENTION

Pearls are unique among gemstones in that they are not mined from the earth but instead grown inside living organic beings. Pearls are grown by live bivalves living underwater. Pearls may form in either salt or fresh water environments in several species of bivalves, such as clams, that are members of the phylum mollusca. The mollusk body includes a head, a foot, a visceral mass and mantle lobes that are encased in a hard calcium carbonate shell. The calcium carbonate in the shell is usually of the aragonite phase. Historically, most of the pearls for the jewelry trade came from the marine bivalves Pinctada vulgaris and P. margaratifera. These bivalves were abundant in the Persian Gulf, where the environmental conditions were favorable—a water depth of generally about 15-20 meters.

Fresh water pearls have been found in several species of clams living in the rivers of the United States. Most of these are grown in the mollusk species Unio, and are becoming the basis of a fresh water cultured pearl industry in parts of the United States. Pearls form when a calcite-based irritant becomes lodged between the mantle lobe and shell of the bivalve (contrary to popular belief, the irritant must be clacium-based for the layering to adhere—pearls do not form around grains of sand). When a foreign particle penetrates the mollusk, shell secreting cells attach to the particle and start building up more or less concentric layers of pearl around it. The bivalve secretes the protective layers of aragonite platelets around the irritant to isolate it from the soft tissue inside the shell. As long as the irritant is present within the bivalve, the layering process continues. Eventually, a pearl is formed as the result of aragonite layering over the irritant. Ideally (from a jeweler's perspective) the pearl nucleus will become separated from the shell and become completely surrounded by the mantle, resulting in a loose and spherical pearl. More often, a loose but non-spherical pearl will form as the result of uneven deposition of the aragonite. Sometimes the nucleus does not become separated from the shell, resulting in a aragonite blister on the inside of the shell. Irregular shaped pearls called baroque pearls are those that have grown in muscular tissue; pearls that grow adjacent to the shell are often flat on one side and are called blister pearls.

To the naked eye, a pearl in cross section will appear to have concentric, smooth layers. However, magnification reveals the layers to be composed of an imbricate structure as a result of the aragonite deposition process. The aragonite is deposited as overlapping platelets. The platelets are in turn adhered together by an conchiolin, an organic cementing agent. Further magnification of the pearl surface reveals irregular topographic contours. The pearl derives its iridescence from the diffraction and interference of white light by the overlapping platelets of aragonite. The iridescence (or orient) of the pearl is a function of the both numbers and thicknesses of these platelets.

Mother of pearl (or nacre) forms on the inner walls or inner surfaces of the mollusk shell. Mother of pearl differs from pearl inasmuch as it is part of the mollusk shell whereas the pearl has become a separate entity from the shell. Several factors influence the value of pearl and these include color, luster, iridescence, shape, and size. Large, spherical pearls are the most desired least produced, and therefore command higher prices. Popularity of pearl colors varies from place to place and culture to culture. For example, cream rose' and light rose colors tend to be popular while pure white or pure yellow pearls are generally disfavored. Likewise, oblong, tear drop or flat pearls are usually less popular and thus command lower premiums. Semi-translucent pearls with high luster are more desired than opaque pearls with low luster. Orient is also quite important to grading pearls. Strings of pearls are graded not only on the above criteria but also how well the colors and luster of the individual pearls match in the total piece.

While artificial pearl substitutes have been made from various resins and plastics, they are relatively worthless. The only viable alternative to the natural pearl is the cultured pearl. A cultured pearl is produced by inserting a calcite irritant (typically a rounded bead of nacre or clam shell) between the shell and mantle of the bivalve. The pearl culturing industry was originated in Asia in the thirteenth century where oysters of the species Pinctada martensii were used as hosts, and has changed little since then. Today, nacre beads are still inserted in oysters that are about three years old, and the resulting pearls are harvested in one to two years. The oyster secretes calcium carbonate around the irritant at an annual rate ranging from about 0.1 to 0.2 millimeters. Although pearl farming began in Japan, the industry has spread to parts of Australia and America, where culturing fresh water pearls has flourished. Less than 38% of the oysters so cultured will produce a pearl and only a small fraction of those are considered to be of fine quality. For this reason, cultured pearls tend to be costlier than freshwater pearls. Cultured pearls are nearly indistinguishable from natural pearls, with the only generally accepted distinction technique being X-ray analysis, wherein the nucleus is imaged.

Cultured pearls are currently grown through the introduction of natural calcite irritants into the bivalve around which a pearl is formed. These irritants are currently produced by breaking natural calcite sources, such as oyster and clam shells, into fragments and grinding the fragments into tiny spheres. This process is costly, since the grinding operations are performed on relatively small, hard bodies. Currently, the method for converting regular non-spherical bodies, such as cubes or cylinders, into spheres is laborious and inefficient. Several methods are used, ranging from tumbling to grinding samples between counter-rotating, parallel plates (including those accomplished using a spiral geometry), to polishing individual spheres in a lathe-type apparatus. Each of the current methods has significant limitations for grinding soft, brittle materials (such as most ceramic bodies) in a non-spherical shape into spheres Examples of soft, brittle materials include those prepared from ceramic or metal powders prior to, and even after, sintering. The tumbling method tends to produce the minimum amount of damage to the specimen, but also tends to produce non-spherical samples when complete. The counter-rotating, parallel plate method tends to be too aggressive for soft, brittle materials. The lathe-type apparatus can only produce one sphere at a time, and is therefore inefficient. The last two methods, in particular, were developed for the purpose of converting hard, tough materials into spheres (such as stones and ball bearings).

Using natural irritants in culturing pearls also necessitates a plentiful source of shells. Such a shell source is not unlimited, and is being depleted faster than it is being replenished. Thus, a need persists for an alternative source of pearl seed around which pearls may be cultured. The present invention addresses this need.

### SUMMARY OF THE INVENTION

The present invention relates to a method for liquid-phase sintering calcium carbonate bodies. The method includes forming bodies from a substantially calcium carbonatious starting powder having a surface area of at least about 15 square meters per gram into partially densified green bodies, humidifying the green bodies to have a moisture content of between about 5 weight percent and about 8 weight percent, and then placing the bodies in a pressure chamber. The pressure chamber is then substantially evacuated, substantially pressurized with carbon dioxide gas, again substantially evacuated, and then pressurized with carbon dioxide gas to a pressure of between about 600 PSI and 750 PSI.

The present invention also relates to a method for producing pearl seeds, i.e., nuclei around which cultured pearls may be grown, including forming bodies from a calcium carbonate precursor powder, equilibrating the moisture content of the bodies to a level of between about 5 weight percent and about 8 weight percent, partially densifying the bodies, spheroidizing the bodies to produce calcium carbonate spheres, sintering the calcium carbonate spheres to produce densified seeds, and tumbling the densified seeds in fluidized calcite.

The present invention further relates to a method for producing a cultured pearl, including forming a body from a calcium carbonate precursor powder, equilibrating the moisture content of the body to a level of between about 5 weight percent and about 8 weight percent, partially densifying the body, spheroidizing the body to a produce calcium carbonate sphere, sintering the calcium carbonate sphere to produce a densified seed, tumbling the densified seed in fluidized calcite, placing the densified seed between the mantle lobe and the shell of a bivalve, growing a pearl around the seed, and harvesting the pearl from the bivalve. The pearl is preferably grown for a duration of about 2 to about 3 years.

The present invention still further relates to a cultured pearl, including an inner nucleus formed of sintered calcium carbonate and an outer shell formed of aragonite platelets. The outer shell is formed by a bivalve by the deposition of nacreous layers onto the nucleus.

The present invention yet further relates to a method for making spheres from non-spherical soft, brittle bodies using a modified vibratory mill including a plate operationally connected to a vibration source and having a plurality of substantially equiaxial, substantially cylindrical recesses. The spheres are made by placing a non-spherical body in a recess, vibrating the plate for between about 0.5 and 1.5 hours, and preventing dust from accumulating in the recess. Each recess is substantially lined with an abrasive grit material, contains no more than one body, and is substantially larger than the contained body.

One object of the present invention is to provide an improved method of growing cultured pearls. Related objects and advantages of the present invention will be apparent from the following description.

### BRIEF DESCRIPTION OF THE DRAWINGS

FIG. 1 is a flow-chart illustrating a process for producing artificial pearl nuclei according to a first embodiment of the present invention.

FIG. 2 is a perspective view of a vibratory mill used in the process of FIG. 1.

FIG. 3 is a perspective view of a sintering chamber used in the process of FIG. 1.

FIG. 4A is a photomicrograph of two seeds produced according FIG. 1.

FIG. 4B is an enlarged partial view of one of the seeds of FIG. 4A.

FIG. 4C is an enlarged partial view of one of the seeds of FIG. 4B.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

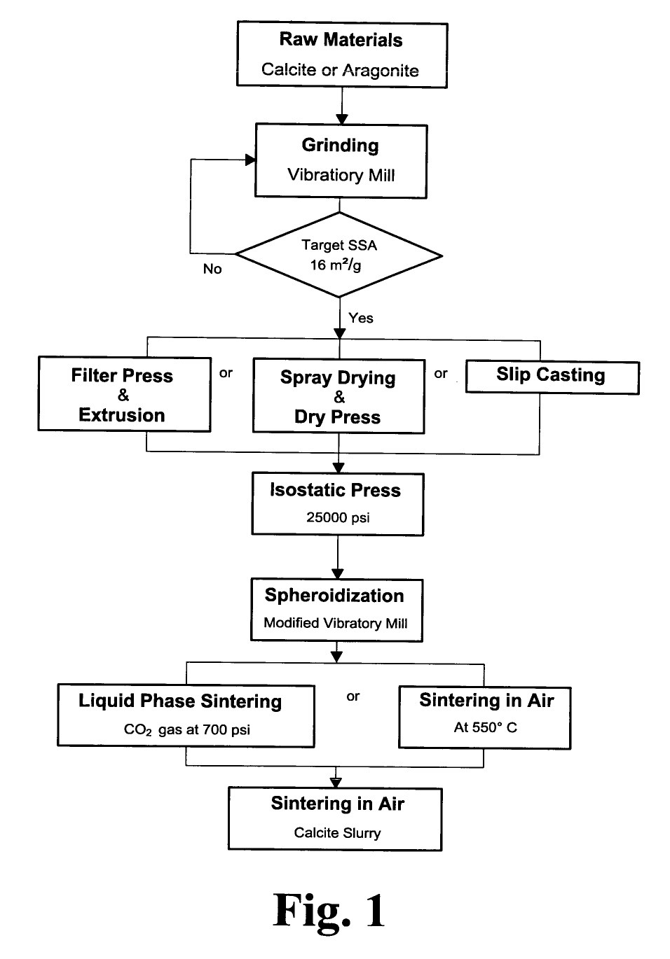

The present invention relates to the use of man made calcium carbonate nuclei or seeds around which cultured pearls may be grown in a bivalve, the method of making the seeds, the seeds themselves, and the cultured pearls so produced. FIG. 1 schematically illustrates the seed production process. The seeds are made from a calcium carbonate powder precursor. The calcium carbonate powder precursor is preferably of either the phase aragonite or calcite, or some blend of the two. Calcite is typically obtained from limestone or by precipitation and aragonite from seashells. Precipitated calcite is less preferred as a source powder for pearl nuclei due to the presence of a surface area stabilizing surface-active agent that tends to interfere with the sintering process. Preferably, the calcium carbonate powder precursor has an impurity level of less than 1.0 percent, and more preferably the calcium carbonate powder precursor has an impurity level of less than 0.1 percent.

The calcium carbonate powder precursor is also preferably characterized by a surface area of 15 square meters per gram of powder (preferably measured by the well known nitrogen absorption BET technique), and is more preferably characterized by a surface area of between about 16 and 18 square meters per gram. The preferred surface area of the calcium carbonate powder precursor may be obtained by milling the calcium carbonate source (such as limestone or seashell) until the so-produced calcium carbonate particles are sufficiently fine to have the required aggregate surface area. A wet-milling (vibratory or ball milling) process is recommended, but any convenient milling process may be chosen. If wet-milling, the use of dispersants should be avoided since dispersants may adversely affect the sintering process and/or the performance of later-produced pearl nuclei during pearl formation. The solids loading of the wet mill should be on the order of 15 volume percent. Excessive solids loading decreases the efficiency of the milling process. Also, the increase in viscosity associated with particle size reduction hampers the acquisition of the surface area target. Milling times are typically on the order of 20 hours, but vary according to mill and media size. The calcium carbonate powder is then formed into a green bodies (either quasi-spherical blanks or directly into a spheres).

If the calcium carbonate precursor has been prepared via wet-milling, the resultant slurry is first de-watered if the preferred green body forming step is plastic forming, dry pressing or the like. Alternately, the viscosity of the slurry may adjusted via slightly de-watering or, alternately, thinning with additional water a wet-forming step, such as slip-casting, is used.

If the green bodies are to be formed by extrusion, the slurry is preferably de-watered using filter press technology to produce a plastic body. The moisture content of the plastic body is preferably in the range of between about 18-22% dry weight basis (d.w.b.). The optimum moisture content is a function of the extrusion equipment and the extrusion die. If dry pressing is to be used to form the green bodies, the slurry is preferably spray-dried to a moisture content of between about 1.5-3.5% (d.w.b.). The optimum dry pressing moisture content will vary with desired the nuclei size. If the green bodies are to be formed via slip casting, no preliminary de-watering is necessary since slip casting is a de-watering process.

For extrusion, rods of CaCO₃ are preferably extruded at a diameter of approximately 1.5 times the final desired nucleus size. For example, if a 6 mm nucleus is desired, a 9 mm extrusion is recommended. The rods are next dried to a moisture content of between about 12-15% and then cut to produce an equiaxed right circular cylinder “blank.” If the “blank” is not equiaxed, it is more difficult to produce a sphere after grinding. Extrusion has been determined to be a preferred route to blank formation, primarily due to the ease of obtaining uniform particle packing (i.e., a minimization of density gradients). Density gradients lead to an increased likelihood of non-uniform sintering and unstable nuclei when introduced to water.

If dry pressing is to be used, the fill must be adjusted to create an equiaxed pellet after pressing. The moisture content should be optimized to avoid the occurrence of density gradients. The use of a die lubricant is preferably avoided, as residual die lubricant adhering to the piece may potentially interfere with sintering. The cylinder blank is once again preferably sized to be 1.5 times the diameter of the desired final sphere. If a spherical blank is produced, the blank should be 1.2 times the final desired diameter. If spherical blanks are produced by pressing, extra care is recommended to ensure uniform particle packing (green density).

Slip casting of nuclei blanks is preferably accomplished using gypsum or polymeric molds, in either a conventional bench solid-casting process (as opposed to drain casting) or by a pressure casting process, although the blanks may be produced by any convenient slip-casting technique. If casting is used, spherical blanks can be produced, eliminating the need for an intermediate sphere grinding step.

The moisture content of the green bodies should be adjusted to fall between about 5% and about 8% (d.w.b.). This may be accomplished by drying (in the case of extrusion and slip cast blanks) or by hydration (in the dry pressing case). Adjustment by drying is accomplished by drying extradites typically having water contents of between about 25 to 29 percent at a predetermined temperature (preferably 60 degrees Celsius) for a predetermined amount of time (taken from a predetermined experimentally verified drying curve.) Alternately, the extradites may be substantially completely dried and then re-hydrated, such as by prolonged exposure to an environment characterized by a substantially constant controlled humidity or by adding controlled amounts of liquid water back to the extrudites. Thus, the moisture content of the green bodies is preferably adjusted a level appropriate for isostatic pressing.

After the moisture content adjustment operation is performed, the green bodies (now pellets) are preferably stored in a controlled humidity environment prior to further processing to provide sufficient time for moisture content equilibration (producing a uniform moisture content throughout the blank). Preferably, the pellets are stored for about 24 hours. If the moisture content is not within the proper range, the density after isostatic pressing may not be uniform. For example, if the moisture content is too low the pellets tend to crack during isostatic pressing.

After forming, all pellets are preferably densified. More preferably, densification is achieved by isostatically pressing the pellets using a wet bag process. Preferably, the pellets are placed in an isostatic press bag, evacuated, and then pressed in oil to a pressure of about 15,000 psi. Isostatic pressing substantially improves pellet density uniformity. While not essential, isostatic pressing dramatically reduces the incidence of losses.

Next, the green bodies are spheroidized, or shaped substantially into spheres, if they are not already so shaped. One method of spherodizing the green body pellets is by grinding them to a spherical shape, such as by using a modified vibratory mill or the like. The modified vibratory mill includes a plate into which a plurality of substantially equiaxed cylindrical recesses or “grinding cells” have been formed (see FIG. 2). The plate is coupled to a high-amplitude vibratory mill. Each grinding cell has a circular cross-section with a diameter at least about 1.2 times (and more preferably about 1.5 to about 2.5 times) to the largest point-to-point or cross-sectional dimension of the body to be placed thereinto for spheroidization. These bodies are preferred to have regular shapes, although the process may be used on non-regular objects as well. The grinding cells are preferably constructed to allow the powder generated by the grinding process to be easily removed, since a build-up of grinding powder interferes with the grinding process and may impair the spheroidization of the pellet. Preferably, the powder is removed via a vacuum pump connected in fluidic communication with each of the grinding cells. Each grinding cell is preferably lined with an abrasive, such as conventional sand paper (aluminum oxide or garnet paper) or the like. Preferred grit sizes are in 60 to 220 mesh range, and more preferred grit sizes are in the 100 to 150 mesh range. Of course, other grit sizes may be chosen.

The recesses are preferably positioned so as to have an optimum distance from the center of the plate and mill—recesses to close to the center tend to produce smaller spheres and recesses to far from the center tend to produce larger and/or incomplete spheres.

The shape of the bodies to be spheroidized is preferably cylindrical (as cylinders with substantially uniform dimensions and properties are relatively easy to produce), and more preferably have height dimensions about 0.90 to 0.95 times their diameters for easier spheroidization (1:1 height to diameter ratios tend to yield slightly elliptical spheres for the same milling duration as is required to substantially spherodize cylinders of the preferred relative dimensions).

Each pellet is placed in its own grinding cell, which preferably is sized to have dimensions of between about 1.5 to 2.0 times the pellet “diameter” (here, taken to be the longest cross-sectional pellet dimension). Typical sufficient grinding times with the preferred milling environment are about 30 minutes; longer grinding times yield smaller spheres. The use of conventional sphere polishing techniques, such as the parallel plate method and the spiral groove method, are viable, albeit less preferred, alternatives. The density of a densified spheroidized pellet is preferably about 2.0 grams per cubic centimeter. The diameter of a densified spheroidized pellet is preferably between about 7 to about 8 millimeters, and the weight of each densified spheroidized pellet is preferably about 0.7 grams.

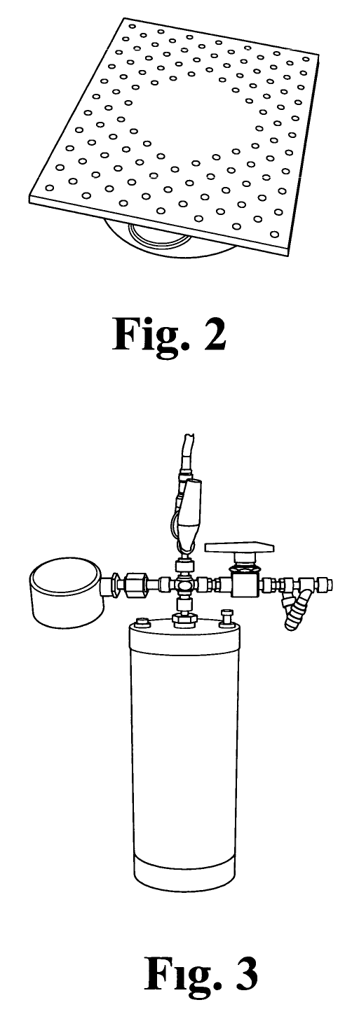

The now-substantially spherical pellets are next sintered to achieve greater density, hardness, durability and other desired end properties. Sintering is preferably accomplished via either liquid phase sintering with water under elevated CO₂ pressure or via heating in air, although other convenient methods of sintering calcium carbonate may be selected. One preferred sintering chamber is illustrated in FIG. 3. It should be noted that the forming processing of the green bodies does not substantially impact the selection of the sintering technique. However, it is preferred that the green bodies be provided with high, uniform density such that sintering may yield homogenous and relatively defect-free pearl nuclei.

Liquid phase sintering is accomplished by exploiting the solubility of calcium carbonate in water as a function of carbon dioxide partial pressure at ambient temperature. In this case, the use of elevated temperatures reduces the tendency of the material to sinter and as such is less preferred than the other sintering mechanisms described herein. The green pellets preferably have a uniform moisture content of between about 5 and about 8% (d.w.b.) for sintering. This may be accomplished, for example, by placing the pellets in a pressure chamber (preferably one capable of 750 psi), evacuating the chamber, back-filling the chamber with carbon dioxide gas, re-evacuating the chamber, and then pressurizing the chamber with carbon dioxide gas to a pressure between about 600 and about 750 psi. Preferably, the carbon dioxide pressure is kept below about 800 psi, as the calcium carbonate will begin to convert to a calcium hydro-carbonate at higher carbon dioxide. Likewise, the carbon dioxide pressure is preferably raised in excess of about 600 psi since below 600 psi the solubility of calcium carbonate in water is insufficient to drive the kinetics of the sintering process at a minimum preferred rate. Preferably, the carbon dioxide pressure is held in the vicinity of 720 psi. Typical sintering times are 15-24 hours, although shorter times can be used. The number of pellets in the sintering chamber does not appear to have any effect on the sintering process. It should be noted that if the surface area of the starting powder is below 15 m²/g, the kinetics are unfavorable and sintering does not occur at an appreciable rate.

Alternately, sintering can be accomplished in air at temperatures well below the 850° C. decomposition temperature for calcium carbonate. The preferred maximum temperature for heat assisted sintering is recommended to be 550° C. At temperatures in excess of 550° C., decomposition of the calcium carbonate results in discoloration of the pellets, making them less desirable as pearl nuclei.

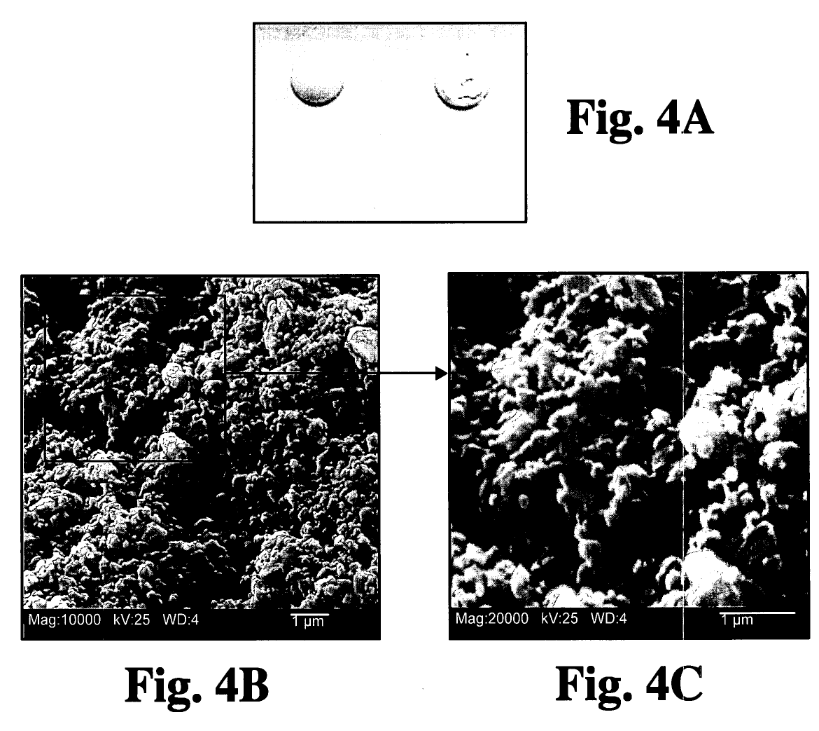

Following sintering, the sintered bodies are then preferably tumbled calcite slurry, and more preferably in a slurry containing 200-mesh (or finer) calcite. The slurry solids loading should be sufficiently low to keep the viscosity low. Preferably, dispersants and polishing aides are absent from the slurry. The preferably tumbling time is about 24 hours. After tumbling, the slurry is dried and generally spherical pearl seeds or nuclei are extracted therefrom. The seeds have preferred diameters of between about 7 and about 8 millimeters, although the seeds may be made to any convenient size. Likewise, the seeds generally weigh about 0.7 grams each, although the weight may be varied as desired by varying the size and/or the density of the seeds. Typical seeds are illustrated in FIGS. 4A-C.

In one alternate embodiment (such as in the case where the pellets are too brittle or weak to withstand the sphere-grinding step after isostatic pressing) the pellets can be first sintered and then ground to a spherical shape. If this route is taken, the grinding times are significantly longer.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for liquid-phase sintering a calcium carbonate body, comprising the steps of:
a) forming a substantially calcium carbonatious starting powder into a partially densified body;
b) humidifying the body to have a moisture content of between about 5 weight percent and about 8 weight percent;
c) placing the body in a pressure chamber;
d) substantially evacuating the pressure chamber;
e) substantially pressurizing the pressure chamber with carbon dioxide gas;
f) after step e) substantially evacuating the pressure chamber; and
g) pressurizing the pressure chamber with carbon dioxide gas to a pressure of between about 600 PSI and 850 PSI;
wherein the starting powder has a surface area of at least about 15 square meters/gram.

2. The method of claim 1 wherein step g has a duration of between about 15 and about 24 hours.

3. The method of claim 1 wherein during step g the chamber is pressurized with carbon dioxide gas to a pressure of between about 700 PSI and 750 PSI.

4. A method for liquid-phase sintering a calcium carbonate body, comprising the steps of:
a) forming a partially densified body having exposed surface particulate surfaces from a precursor powder characterized as being substantially calcium carbonate and having a surface area of at least about 15 square meters per gram;
b) adjusting the moisture content of the partially densified body to be between about 5 weight percent and about 8 weight percent;
c) substantially coating all of the exposed particulate surfaces of the partially densified body with a layer of adsorbed carbon dioxide; and
d) pressurizing the body with carbon dioxide gas to a pressure of between about 650 PSI and about 750 PSI.

5. The method of claim 4 wherein step d has a duration of between about 15 hours and about 24 hours.

6. The method of claim 4 wherein step c includes the following substeps:
c1) exposing the partially densified body to a substantial vacuum;
c2) after step c1), pressurizing the partially densified body with carbon dioxide gas; and
f) after step c2), exposing the partially densified body to a substantial vacuum.

7. The method of claim 4 wherein the precursor powder is chosen from the group consisting of calcite and aragonite.

8. A method for producing pearl seeds, comprising the steps of:
a) forming bodies from a calcium carbonate precursor powder;
b) equilibrating the moisture content of the bodies to a level of between about 5 weight percent and about 8 weight percent;
c) partially densifying the bodies;
d) spheroidizing the bodies to produce calcium carbonate spheres;
e) sintering the calcium carbonate spheres to produce densified seeds; and
f) tumbling the densified seeds in fluidized calcite;
wherein the densified seeds have densities of about 2 grams per cubic centimeter and weights of about 0.7 grams.

9. The method of claim 8 wherein the precursor powder has a surface areas of at least about 15 square meters per gram; wherein step c) further comprises isostatic wet pressing in oil to about 15,000 PSI; and wherein step f) further comprises tumbling the bodies in a slurry of calcite particles smaller than 200 mesh.

10. The method of claim 8 wherein step e) further comprises liquid-phase sintering the bodies.

11. The method of claim 10 wherein step e further comprises:
e1) humidifying the body to have a moisture content of between about 5 weight percent and about 8 weight percent;
e2) placing the body in a pressure chamber;
e3 substantially evacuating the pressure chamber;
e4) substantially pressurizing the pressure chamber with carbon dioxide gas;
e5) after step e) substantially evacuating the pressure chamber; and
e6) pressurizing the pressure chamber with carbon dioxide gas to a pressure of between about 650 PSI and 750 PSI.

12. A method for producing a cultured pearl, comprising the steps of:
a) forming a body from a calcium carbonate precursor powder;
b) equilibrating the moisture content of the body to a level of between about 5 weight percent and about 8 weight percent;
c) partially densifying the body;
d) spheroidizing the body to a produce a calcium carbonate sphere;
e) sintering the calcium carbonate sphere to produce a densified seed;
f) tumbling the densified seed in fluidized calcite;
g) placing the densified seed between the mantle lobe and the shell of a bivalve;
h) growing a pearl around the seed; and
i) harvesting the pearl from the bivalve;
wherein step h has a duration of about 2 to about 3 years;
wherein the densified seed is sized to irritate the bivalve;
wherein the seed has a density of about 2 grams per cubic centimeter; and
wherein the seed weighs about 0.7 grams.

13. The method of claim 12 wherein the partial densification of step c is accomplished via isostatic pressing.

14. The method of claim 12 wherein the calcium carbonate precursor is at least about 99 percent pure.

15. The method of claim 12 wherein the calcium carbonate precursor is at least about 99.9 percent pure.

16. The method of claim 12 wherein the calcium carbonate precursor is aragonite.

17. The method of claim 12 wherein the calcium carbonate precursor is a mixture of calcite and aragonite.

18. The method of claim 17 wherein the calcium carbonate precursor is substantially calcite.

19. The method of claim 17 wherein the calcium carbonate precursor is substantially aragonite.

20. The method of claim 12 wherein the calcium carbonate sphere is liquid phase sintered.

21. The method of claim 12 wherein the densified seed has a diameter of between about 0.7 millimeters and about 0.8 millimeters.

22. A cultured pearl, comprising:
an inner nucleus formed of sintered calcium carbonate; and
an outer shell formed of aragonite platelets;
wherein the outer shell is formed by a bivalve.

23. A pearl formed by inserting an artificial nucleus into a bivalve and then culturing the bivalve to deposit nacreous layers onto the artificial nucleus, wherein the artificial nucleus is formed of sintered calcium carbonate.

24. The pearl of claim 23 wherein the calcium carbonate is liquid-phase sintered in carbon dioxide gas.

25. A method for producing spherical bodies from non-spherical bodies using a modified vibratory mill including a plate operationally connected to a vibration source and having a plurality of substantially equiaxial, substantially cylindrical recesses, comprising the steps of:
a) placing a non-spherical body in a recess;
b) vibrating the plate for between about 0.5 and 1.5 hours; and
c) preventing dust from accumulating in the recess;
wherein each recess is substantially lined with an abrasive grit material;
wherein each recess contains up to one body; and
wherein each recess is substantially larger than the contained body.

26. The method of claim 25 wherein the non-spherical body is characterized by a longest cross-sectional distance, the recess is characterized by a diameter, and wherein the diameter is at least about 1.2 times the longest cross-sectional distance.

27. The method of claim 25 wherein the abrasive material is characterized by a grit size in the range of between about 60 and about 200 mesh.

28. The method of claim 27 wherein the abrasive is characterized by a grit size in the range of between about 100 and 150 mesh.

29. The method of claim 25 wherein the recesses are positioned within a zone bounded by a predetermined minimum distance and a predetermined maximum distance from the vibration source.

30. The method of claim 26 wherein the diameter is between about 1.5 and about 2.5 times the longest cross-sectional distance.
